(19) United States
(12) Patent Application Publication
(10) Pub. No.: US 2013/0143166 A1
(43) Pub. Date: Jun. 6, 2013

(54) RESIST FILM FORMING APPARATUS, RESIST FILM FORMING METHOD, AND MOLD ORIGINAL PLATE PRODUCTION METHOD

(71) Applicant: Tomohide Jozaki, Kanagawa (JP)

(72) Inventor: Tomohide Jozaki, Kanagawa (JP)

(73) Assignee: SONY CORPORATION, Tokyo (JP)

(21) Appl. No.: 13/611,070

(22) Filed: Sep. 12, 2012

(30) Foreign Application Priority Data
Sep. 30, 2011 (JP) 2011-218468

(51) Int. Cl. B05D 5/00

(52) U.S. Cl. CPC B05D 5/00
USPC 430/325; 118/712; 427/8

(57) ABSTRACT

There is provided a resist film forming apparatus including a coating unit configured to drop, rotate, and spread a resist while rotating a substrate, a heating unit configured to heat a specimen in which the resist is coated on the substrate, a metering unit configured to measure a weight of the specimen being heated, and a control unit configured to control lamination of a plurality of resist layers on the specimen by executing a process of forming a resist layer on the substrate by performing heating in the heating unit until a predetermined amount of solvent has evaporated from a resist coated on the specimen based on the measured weight of the specimen, and repeating for a predetermined number of times a process of forming a new resist layer on a resist layer formed on the specimen by similarly controlling the coating unit and the heating unit.

### BACKGROUND

The present disclosure relates to a resist film forming apparatus, a resist film forming method, and a mold original plate production method, and in particular, relates to a technique for performing three-dimensional patterning on a resist film by applying a lithography technique, and processing a mold original plate based on that pattern.

In a typical lithography step, first, a substrate is rotated (e.g., at 3,000 rpm for 20 seconds) by a spin coater to uniformly coat a resist on the substrate. Next, pre-baking is carried out using a flat metal plate (a hot plate) that has been subjected to a surface treatment to evaporate the solvent in the resist layer. Then, light is irradiated on the resist layer through a mask in which a predetermined pattern is formed by an exposure apparatus mounted with a DMD (digital mirror device) and the like. Next, the substrate coated with the resist layer is dipped in a developing solution to remove the portions on the resist film that were not exposed. Finally, post-baking is carried out to evaporate the developing solution that has permeated into the resist layer.

However, in a three-dimensional lithography technique, to increase the height of the target article (e.g., to 100 μm), it is necessary to coat a thick resist on the substrate. In such a case, as illustrated in FIG. 1, a resist 103 is coated on a substrate 102 while rotating a spin coater 110, and pre-baking is carried out using a heated flat metal plate (a hot plate). By repeating this step, a thick resist coating can be formed (refer to the right side of FIG. 1). In the example illustrated in FIG. 1, a first resist layer R1 to a twentieth resist layer R20 are formed on the substrate 102.

The thus-formed three-dimensional resist pattern is used to produce a mold original plate (a master), and this mold original plate is transferred to produce a replica. Then, a desired article can be mass produced using the replica.

However, when a resist is repeatedly coated using the above technique, as illustrated in FIG. 2, a development residue R′ is produced. A development residue is a phenomenon in which when development of the resist is incomplete, resist remains in unnecessary locations. This is thought to be caused by overheating of the resist layer that was coated first due to the subsequent lamination of resist layers, so that the solvent in that resist layer evaporates more than expected, producing a development residue. If heating is weakened in order to suppress the occurrence of a development residue on the resist layer that was coated first, the resist layer that is coated last (e.g., the twentieth resist layer R20) will only be half dry.

One way to resolve this problem would be to, for example, provide a bank around the periphery of the specimen (substrate), and spread out the resist with a spatula-shaped squeegee. However, in this case, the necessary level of solvent evaporation does not occur in the center portion of the thickly coated resist layer due to insufficient heating.

FIG. 3 illustrates an example of a misshapen pattern after exposure obtained when more than 9% of the solvent remains in the resist layer. The sides of the resist pattern P1, which should have a rectangular shape, are distorted, and a large number of patterns like wrinkles P1a are formed even in the interior of the rectangle.

FIG. 4 illustrates a fine pattern after exposure when the solvent in the resist layer has suitably evaporated. A rectangular resist pattern P2 that is free from distortions like those in FIG. 4 can be obtained when overall the solvent in the resist layer has evaporated to a suitable level (e.g., 9% or less).

As a technique for forming a fine structure with a precise pattern on a wafer, for example, JP 2008-130685A discloses a method for processing a fine structure in which a drying treatment is carried out without destroying the fine structure pattern formed on the wafer.

### SUMMARY

When applying a lithography technique, especially when forming a three-dimensional shape, a thick resist has to be coated over an area that greatly exceeds the range in the height direction that has carried out for previous semiconductors and MEMS (Micro Electro Mechanical Systems). Consequently, in the steps for forming and laminating the respective resist layers, even more precise exposure shapes are required.

The present disclosure realizes, in consideration of the above-described circumstances, a precise exposed resist pattern by evaporating a suitable amount of solvent from resist layers.

According to an embodiment of the present disclosure, a specimen coated on a substrate by dropping, rotating, and spreading the resist while rotating the substrate is heated. At this point, the weight of the specimen that is being heated is measured with a metering unit. Then, based on the measured weight of the specimen, a resist layer is formed on the substrate by carrying out heating until a predetermined amount of solvent has evaporated from the resist coated on the specimen. Then, a step of forming a new resist layer on the resist layer formed on the specimen is repeated a predetermined number of times to form a thick resist film by laminating a plurality of resist layers on the specimen.

According to another embodiment of the present disclosure, since the heating can be executed while individually managing the amount of solvent that evaporates from each of the laminated resist layers, a suitable amount of solvent can be evaporated from each resist layer.

According to the embodiments of the present disclosure described above, by laminating resist layers while managing the amount of solvent that evaporates from the resist layers, a precise exposed resist pattern can be realized by evaporating a suitable amount of solvent from each resist layer.

### BRIEF DESCRIPTION OF THE DRAWINGS

FIG. 1 is an explanatory diagram illustrating an outline of a previous lithography step;

FIG. 2 is an explanatory diagram of a development residue;

FIG. 3 is a schematic plan view illustrating an example of a resist pattern when the amount of solvent that has evaporated from a resist layer is unsuitable;

FIG. 4 is a schematic plan view illustrating an example of a resist pattern when the amount of solvent that has evaporated from a resist layer is suitable;

FIG. 5 is an explanatory diagram illustrating an outline of a method for producing a mold original plate that utilizes the resist film forming method according to an embodiment of the present disclosure;

FIG. 6 is an explanatory diagram illustrating a configuration example of a resist film forming apparatus according to an embodiment of the present disclosure;

FIG. 7 is a plan view illustrating an example of thickness measurement locations in a specimen formed using the resist film forming method according to an embodiment of the present disclosure;

FIG. 8 is a graph illustrating the results of measuring the thickness of a specimen according to an embodiment of the present disclosure;

FIG. 9 is a graph illustrating an example of a relationship between baking time and solvent remaining amount in the resist film forming method according to an embodiment of the present disclosure;

FIG. 10 is a cross-sectional view illustrating an example of a resist film formed based on the resist film forming method according to an embodiment of the present disclosure; and

FIGS. 11A to 11C are photograph examples of the surface of a mold original plate formed using previous processing techniques, in which FIG. 11A illustrates a surface processed by spiral processing, FIG. 11B illustrates a surface processed by line scanning processing, and FIG. 11C illustrates a surface processed by aspheric surface processing.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

1. Exemplary embodiment (Oven chamber: example including a metering device)

2. Another embodiment

### 1. Exemplary Embodiment

A method for producing a mold original plate that utilizes the resist film forming method according to an embodiment of the present disclosure will now be described.

[Method for Producing Mold Original Plate]

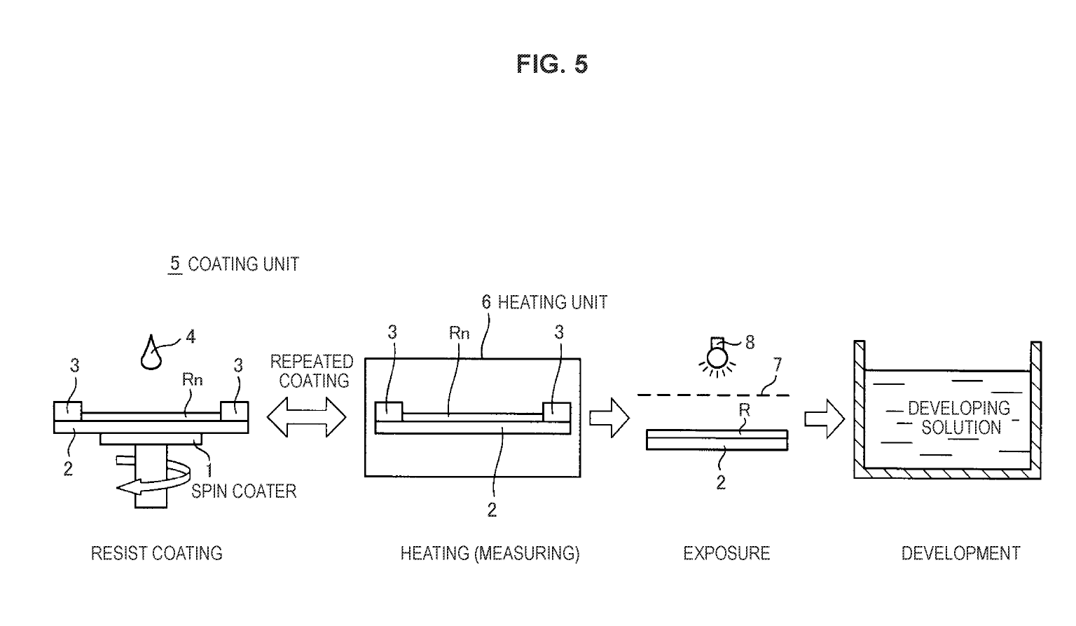

FIG. 5 is an explanatory diagram illustrating an outline of a method for producing a mold original plate that utilizes a resist film forming method according to an embodiment of the present disclosure.

Broadly speaking, the method for forming a mold original plate according to an embodiment of the present disclosure includes a resist coating step, a heating step, an exposure step, a developing step, and a transfer step, and realizes a thick coating of a resist on a substrate by repeating the coating step and the heating step.

(Resist Coating Step)

The resist costing step is a step in which a resist is uniformly coated on a specimen by dropping, rotating, and spreading a resist 4 using a spin coater 1 while rotating (e.g., for 20 seconds at 1,000 rpm) a substrate 2 made of glass or the like in a horizontal plane. The spin coater 1 is one element of a coating unit 5.

In this resist coating step, it is desirable to provide a bank portion 3 (wall) on a periphery of the substrate 2 or on an upper face and peripheral portion of the substrate 2. By providing this bank portion 3, a circumferential portion of the resist spread in a radial direction after the coating can contact and latch onto the bank portion 3, thereby allowing a thick film of resist to be coated. For example, a bank portion 3 that is 0.6 mm in height may be provided using so-called Teflon®, which is polytetrafluoroethylene (a fluororesin).

The resist 4 may be a material that is sensitive to photons in light, an electron beam and the like. For example, in the present embodiment, a negative-type resist is used that has a characteristic of becoming insoluble or poorly soluble in the developing solution when irradiated with light, X-rays, or an electron beam, so that it remains on the substrate surface until after development. Depending on the desired shape, a positive-type resist having the opposite characteristic can also be used as appropriate.

(Heating Step)

The heating step is a step of heating (also called “baking”) the substrate 2 on which the resist 4 has been coated, namely, the specimen, with a box-shaped heating unit 6 such as an oven. Heating with a heating unit 6 that has a box-shaped closed space traps the steam produced from the heated air and the specimen inside the box, prevents overheating of the resist layers, prevents too much evaporation of the solvent, and facilitates adjustment of the amount of evaporated solvent. In this example, one resist layer is heated for 5 minutes at 100° C.

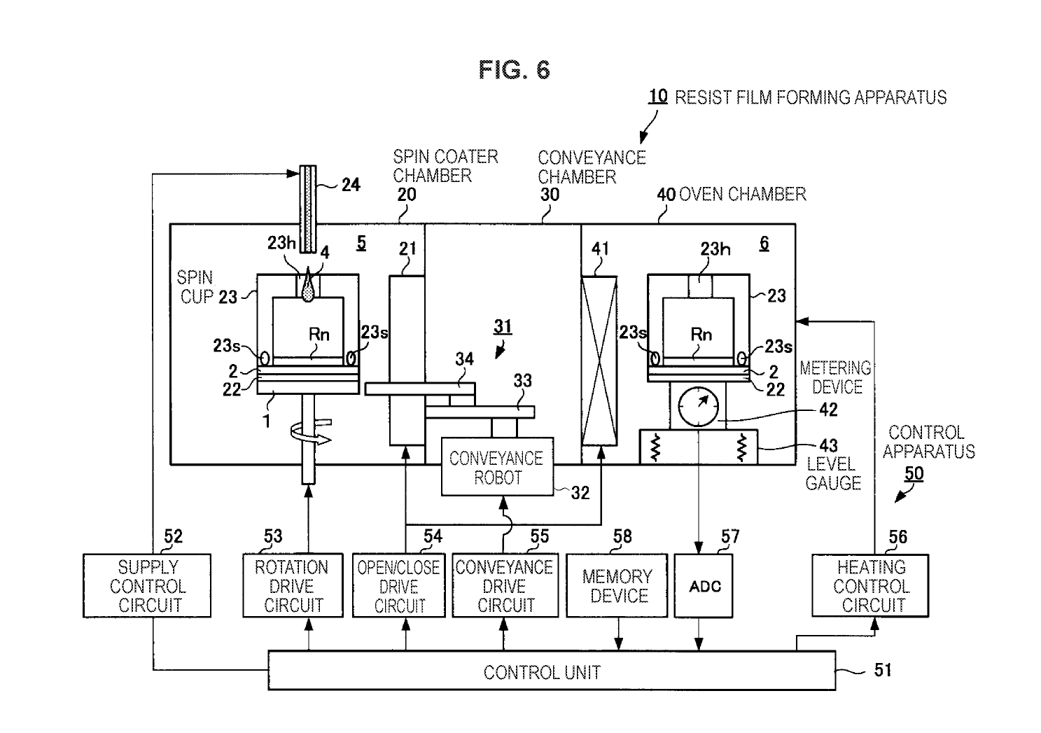

In the heating step, the weight of the specimen being heated is measured. Then, based on the measured specimen weight, heating is carried out until a predetermined amount of solvent has evaporated from the resist coated on the specimen, so that a resist layer Rn is formed on the substrate 2. This measurement and the control carried out based on the measurement result are important features of the present disclosure. The measurement method will be described below with reference to FIG. 6.

In this heating step too, by providing the bank portion 3 on the specimen, a circumferential portion of the resist spread in a radial direction can contact and latch onto the bank portion 3, thereby preventing the resist from flowing out due to the heat, and enabling a thick film of resist to be coated.

The above-described resist coating step and heating step are repeated a predetermined number of times to laminate resist layers on the specimen, whereby a resist film R formed from a plurality of resist layers is formed in a desired thickness on the substrate 2.

(Exposure Step)

The exposure step is a step of irradiating light on the resist film R, in which a plurality of resist layers Rn are laminated, through a mask having an opaque portion for partial control of the exposure amount.

For example, light from a light source 8 is irradiated on the resist film R, in which resist layers are laminated, through a mask 7 in which a predetermined pattern is formed by an exposure apparatus mounted with a DMD (digital mirror device). Examples that may be used for the mask 7 include masks known as a graytone mask or a photomask that have an opaque portion for three-dimensional processing of the resist film R.

(Developing Step)

The developing step is a step of developing the exposed specimen to form a predetermined three-dimensional pattern on the resist film R.

For example, the exposed specimen is dipped in a developing solution to remove the portions on the resist film that were not exposed. Typically, after development it is common to carry out a treatment for washing off the developing solution that has permeated into the resist film R with a rinse solution, or to carry out a heat treatment known as “post-baking” to evaporate adhered developing solution or rinse solution. In the present disclosure too, washing with a rinse solution or post-baking can be performed.

When the above-described developing step finishes, a mold original plate formed with a predetermined three-dimensional pattern is obtained. This predetermined three-dimensional pattern on the mold original plate is transferred onto a resin and the like to produce a replica (a mold).

[Configuration Example of Resist Film Forming Apparatus]

Next, a resist film forming apparatus for forming a resist film by executing the resist film forming step and the heating step in the mold original plate production step will be described.

FIG. 6 is an explanatory diagram illustrating a configuration example of a resist film forming apparatus according to an embodiment of the present disclosure.

A resist film forming apparatus 10 according to an embodiment of the present disclosure is formed from three spaces, a spin coater chamber 20, a conveyance chamber 30, and an oven chamber 40 for heating the specimen.

The spin coater chamber 20 is provided with, as the coating unit 5, a spin coater 1 and a resist supply member (a nozzle 24) for coating the resist 4 from an upper face of the specimen. A rotation stage for the spin coater 1 (an example of a rotation unit) is provided at a lower portion of the spin coater chamber 20. A conveyance tray 22 is arranged on an upper face of the rotation stage. The specimen is rotated while mounted on the conveyance tray 22, and the resist 4 is dropped thereon from the nozzle 24. A spin cup 23 that enables thick coating of the resist 4 is provided on an upper face of the conveyance tray 22 and the substrate 2 in such a way that prevents the spin cup 23 from becoming mispositioned even due to the rotation of the spin coater 1.

The spin cup 23 has the same function as the bank portion 3. For example, the spin cup 23 may be a cylindrical (or cone-shaped) container that does not have a bottom portion on the side opposing the substrate 2. The shape of the spin cup 23 takes into account factors such as gas emission or resist ricochet during coating, and convection of the steam produced during the subsequent heating (heating efficiency and quality). The spin cup 23 is provided on an upper face of the substrate 2, with a lower face of the cylindrical cylinder portion (or cone-shaped conic surface) positioned near an outer circumferential portion of the upper face of the substrate 2.

An adhesive 23a is coated on a lower face of the spin cup 23, so that this lower face is closely adhered to the upper face of the substrate 2. Consequently, leakage of the resist from a gap between the specimen and the spin cup 23 is prevented. Further, a lid portion is provided on an upper face of the spin cup. A resist droplet passage hole 23h is formed in this lid portion at a place corresponding to the course that the resist 4 droplets fall.

The conveyance chamber 30 is provided mid-way between the spin coater chamber 20 and the oven chamber 40. A conveyance unit 31 for simultaneously conveying the specimen, the spin cup 23, and the conveyance tray 22 is provided in the conveyance chamber 30. The conveyance unit 31 has a conveyance robot 32. The conveyance tray 22 is conveyed between the spin coater chamber 20 and the oven chamber 40 by being transported by a first arm 33 and a second arm 34 of the conveyance robot 32.

The heating unit 6 for heating the specimen is provided in the oven chamber 40. In the present embodiment, an oven is employed as an example of the heating unit 6. This oven traps in its interior the heated air and the steam produced from the specimen, prevents overheating of the resist layer, prevents too much evaporation of the solvent, and facilitates adjustment of the amount of evaporated solvent.

A metering device 42 (an example of a metering unit) for measuring the weight of the specimen is provided on a lower side of the heating unit 6 to measure the amount of solvent in the resist coated on the specimen that has evaporated. The metering device 42 is arranged so that its upper face is horizontal. Further, a level gauge 43 (an example of a levelness maintenance unit) for maintaining a precise levelness is provided on a lower side of the metering device 42 so that the specimen can be maintained in a horizontal state during the heating.

A first shutter 21 and a second shutter 41 are provided as a partition between the spin coater chamber 20 and the conveyance chamber 30, and between the conveyance chamber 30 and the oven chamber 40, respectively.

The first shutter 21 between the spin coater chamber 20 and the conveyance chamber 30 is for preventing the resist coated in the spin coater chamber 20 from splattering on the conveyance robot 32 in the conveyance chamber 30.

The second shutter 41 between the conveyance chamber 30 and the oven chamber 40 is provided to prevent the solvent evaporating from the resist when the specimen is heated in the spin coater chamber 20 due to the introduction of hot air from the oven chamber 40 into the spin coater chamber 20.

The resist film forming apparatus 10 includes a control apparatus 50 for controlling operation of the various pieces of equipment in the spin coater chamber 20, the conveyance chamber 30, and the oven chamber 40.

The control apparatus 50 includes a supply control circuit 52 for controlling a resist supply operation of the coating unit 5, a rotation drive circuit 53 for controlling a rotation operation of the spin coater 1, an open/close drive circuit 54 for controlling an open/close operation of the first shutter 21 and the second shutter 41, a conveyance drive circuit 55 for controlling a conveyance operation of the conveyance robot 32, and a heating control circuit 56 for controlling a heating operation of the heating unit 6.

The control apparatus 50 also includes an analog/digital conversion circuit (hereinafter referred to as “ADC”) 57 for converting analog signal measurement data input from the metering device 42 into a digital signal and outputting the digital signal, and a non-volatile memory device 58 (an example of a storage unit) for storing a threshold for the permitted amount of solvent evaporating from the resist layers. If using a volatile memory device, the threshold needs to be pre-stored in the memory device each time the control apparatus 50 is started up. The resist coating conditions, resist heating conditions, threshold for the permitted amount of solvent that evaporates and the like are stored in the memory device 58.

In addition, the control apparatus 50 includes a control unit 51 that outputs control signals to the circuits 52 to 57 and the memory device 58, inputs and outputs data, and executes control and calculations in the operation of the circuits 52 to 57 and the memory device 58. The control unit 51 is, for example, a calculation processing device such as a MPU (Micro-Processing Unit), which executes the desired control and calculations based on programs and data stored in the memory device 58.

[Resist Film Forming Method]

First, in the spin coater chamber 20, the substrate 2 is placed in the conveyance tray 22 arranged on the rotation stage of the spin coater 1.

After the control unit 51 has detected a manually input signal from a monitoring person or a signal output from a (not illustrated) sensor to confirm that the substrate 2 has been placed on the conveyance tray 22, the control unit 51 outputs a control signal to the supply control circuit 52 based on a program stored in the memory device 58. Under control by the supply control circuit, an appropriate amount of the resist 4 is supplied from the resist supply member nozzle 24. The resist 4 supplied from the nozzle 24 passes through the resist droplet passage hole 23h formed in the upper face (lid portion) of the spin cup 23, and is dropped onto the substrate 2.

After the resist 4 is dropped onto the substrate 2, the control unit 51 outputs a control signal to the rotation drive circuit 53 to make the spin coater 1 rotation stage rotate. The spin coater 1 rotation stage is rotated at a predetermined speed for several dozen seconds, for example at 1,000 rpm for 20 seconds. The resist 4 dropped in the substrate 2 spreads in a radial direction by the centrifugal force of rotation, so that a first resist layer is uniformly coated on the substrate 2 (initial resist coating step).

The greater the speed of the spin coater 1, the thinner the thickness of the resist layer after being rotated and spread. Generally, the thinner the thickness of a film, the easier management is during the heat treatment. However, in the resist film forming method according to an embodiment of the present disclosure, since the heating and film forming steps are carried out while managing the amount of solvent that evaporates from each of the laminated resist layers, resist layers having good uniformity can be formed even for resist layers that are thicker than previously. Therefore, the number of resist layers forming the resist film can be suppressed by decreasing the speed of the spin coater 1 to 1,000 rpm, for example, to increase the thickness per resist layer. Consequently, the number of times the step of forming the resist layers (coating step and heating step) is performed can be decreased, which allows the resist film forming time and the mold original plate production time to be shortened.

After the first resist layer has been coated, the control unit 51 stops the rotation of the spin coater 1, outputs a control signal to the open/close drive circuit 54, and sequentially opens the first shutter 21 and the second shutter 41. Then, the control unit 51 controls the conveyance robot 32 by outputting a control signal to the conveyance drive circuit 55, so that the conveyance tray 22 on which the substrate 2 (specimen) coated with the first resist layer is placed which is in the spin coater chamber 20 is conveyed via the conveyance chamber 30 to the oven chamber 40, and arranged on the upper face of the metering device 42. After the first arm 33 and the second arm 34 of the conveyance robot 32 have returned to the conveyance chamber 30 side, the second shutter 41 is closed. To prevent hot air from flowing to the spin coater chamber 20 at this stage, the first shutter 21 may be closed ahead of the second shutter 41.

After the control unit 51 has detected an output signal from the metering device 42, for example, to confirm that the conveyance tray 22 on which the specimen is placed has been arranged on the metering device 42 in the oven chamber 40, the control unit 51 acquires the measurement data about the weight of the specimen before heating (and immediately after heating) from the metering device 42. Then, the control unit 51 outputs a control signal to the heating control circuit 56 based on a program stored in the memory device 58, and heats the specimen at a predetermined temperature. During the heating of the specimen, the metering device 42 periodically feeds the measurement data about the specimen weight to the control unit 51 via the ADC 57 (initial heating step). Note that it is preferred for the control unit 51 to set the environment in the oven chamber 40 to the same state as during the heating by the time the specimen is conveyed to the oven chamber 40.

The control unit 51 continuously calculates the amount of solvent that has evaporated from the first resist layer based on the specimen weight before heating and the specimen weight during heating, and compares that result with the threshold for the first resist layer evaporation amount stored in the memory device 58.

If the amount of solvent that has evaporated from the first resist layer has reached the prescribed solvent evaporation amount, the control unit 51 outputs a control signal to the open/close drive circuit 54 and the conveyance drive circuit 55 to open the second shutter 41. Then, the conveyance tray 22 on which the specimen is placed is conveyed to the conveyance chamber 30 by the conveyance robot 32, and the second shutter 41 is closed. Next, the control unit 51 opens the first shutter 21, again conveys the conveyance tray 22 to the spin coater chamber 20, arranges the conveyance tray 22 on the spin coater 1 rotation stage, and closes the first shutter 21.

The control unit 51 then uniformly coats a second resist layer (second resist coating step) on the specimen, namely, the first resist layer on the substrate 2, by controlling the supply control circuit 52 and the rotation drive circuit 53. Even if resist layers are stacked, a thick coating of the resist can be obtained by the spin cup fixed above the specimen.

After coating the second resist layer on the specimen, the control unit 51 controls the open/close drive circuit 54 and the conveyance drive circuit 55 so that the conveyance tray 22 on which the specimen coated with the second resist layer is placed is conveyed to the oven chamber 40. Then, the control unit 51 again executes the above-described heat treatment (second heat treatment).

Further, the control unit 51 continuously calculates the amount of solvent that has evaporated from the second resist layer based on the specimen weight before heating and the specimen weight during heating, and compares that result with the threshold for the second resist layer evaporation amount stored in the memory device 58.

If the amount of solvent that has evaporated from the second resist layer has reached the prescribed solvent evaporation amount, the control unit 51 conveys the conveyance tray 22 on which the specimen is placed from the oven chamber 40 to the spin coater chamber 20, and performs coating of the third resist layer on the specimen. After the third resist layer has been coated, the control unit 51 conveys the conveyance tray 22 on which the specimen is placed from the spin coater chamber 20 to the oven chamber 40, and heats the specimen. Then, the control unit 51 continuously calculates the amount of solvent that has evaporated from the third resist layer based on the specimen weight before heating and the specimen weight during heating, compares that result with the threshold for the third resist layer evaporation amount stored in the memory device 58, and based on that comparison result, performs the following control. By repeatedly executing such a resist coating step and heating step, resist layers can be laminated on the specimen until the target number of layers, thereby forming a thick resist film R in which the remaining amount of solvent in the resist has been adjusted to a suitable level (fourth and subsequent resist coating steps and heating steps).

After the thick resist film R has been formed on the specimen, as illustrated in FIG. 5, light is irradiated on the resist film R, which is formed by laminating a plurality of resist layers, through the mask 7 having an opaque portion for partial control of the exposure amount (exposure step).

Then, the exposed specimen is dipped in a developing solution (developing step). After development has been completed, a mold original plate is obtained on which a predetermined three-dimensional pattern is formed on the resist film R.

A replica (mold) is produced by heating this mold original plate having a predetermined three-dimensional pattern, and transferring the predetermined three-dimensional pattern onto a resin, for example, by pressing the mold original plate. A molded article can be produced using this replica.

[Measurement Data about the Mold Original Plate]

The advantageous effects of an embodiment according to the present disclosure will now be described based on measurement data about the mold original plate provided by the method according to the present disclosure.

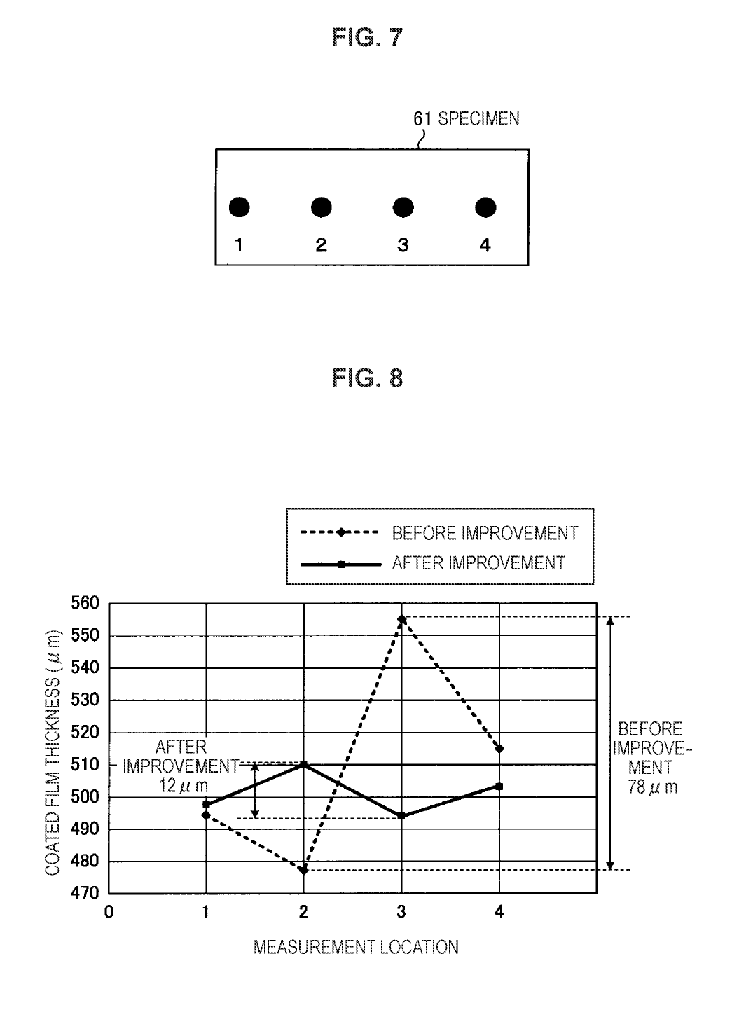

FIG. 7 illustrates locations where the thickness of the resist film for a given specimen are measured. FIG. 8 is a graph illustrating the results of measuring the thickness of the resist film of that specimen.

The specimen 61 illustrated in FIG. 7 was formed by cutting a specimen formed with a resist film using the resist film forming method according to the present disclosure into, for example, a rectangular shape. In this example, the film thickness is measured at four locations (points 1 to 4) along a longitudinal direction of the rectangle. The measurement data is, as illustrated in FIG. 8, plotted along with measurement data obtained based on a previous method with the measurement locations on the horizontal axis and the film thickness on the vertical axis.

As illustrated in FIG. 8, in a previous method (Before Improvement: dotted line), there was a difference of about 78 μm in film thickness depending on the measurement location. However, with the resist film forming method according to the embodiment of the present disclosure (After Improvement: solid line), the difference in thickness of a 500 μm film, for example, was substantially improved, at 12 μm. This illustrates the fact that the thickness of the resist film formed by laminating a plurality of resist layers was generally the same regardless of the measurement location.

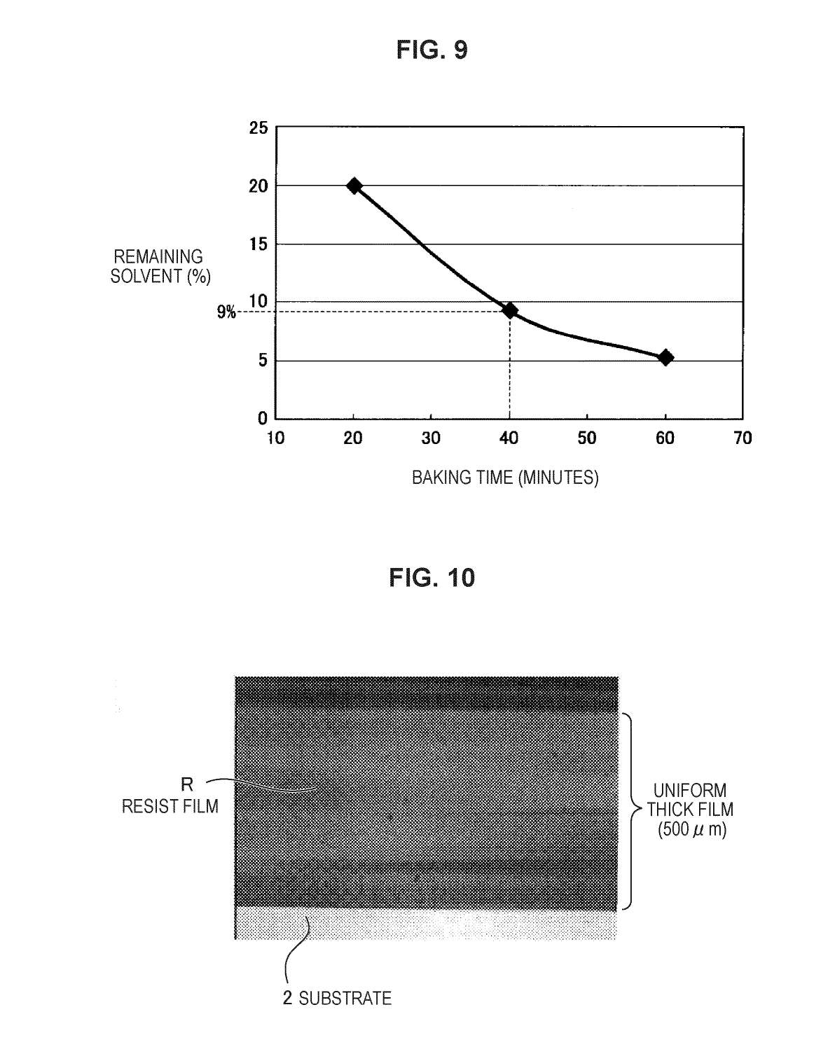

FIG. 9 is a graph illustrating a relationship between baking time (minutes) for a specimen and solvent remaining amount (%).

The baking time is the cumulative heating time of the respective resist layers. In the example illustrated in FIG. 9, a result was obtained in which when the cumulative heat treatment time for a resist film formed using a given resist exceeds 40 minutes, the remaining amount of solvent decreases to 9% or less, so that solvent residue is not produced.

FIG. 10 is a cross-sectional view of an example of a resist film formed by the resist film forming method according to an embodiment of the present disclosure.

As illustrated in FIG. 10, by using a resist film formed by the resist film forming method according to an embodiment of the present disclosure, the thickness of a resist film R having a thickness of 500 μm can be formed uniformly.

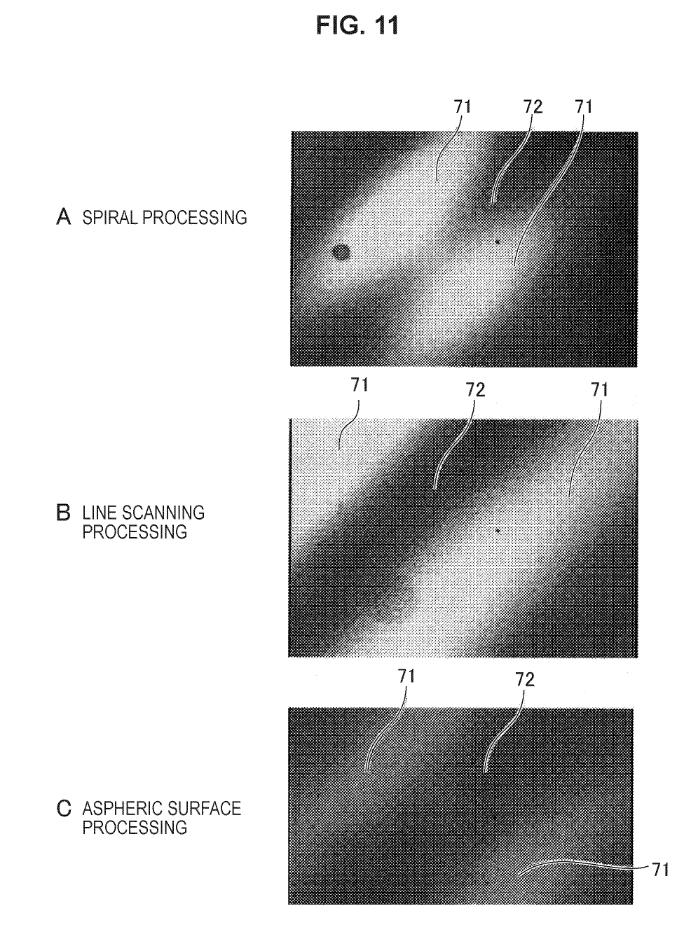

FIGS. 11A to 11C are photograph examples of the surface of a mold original plate formed using a previous processing technique (mechanical processing). FIG. 11A illustrates a surface processed by spiral processing, FIG. 11B illustrates a surface processed by line scanning processing, and FIG. 11C illustrates a surface processed by aspheric surface processing.

In the examples illustrated in FIGS. 11A to 11C, since bright portions 71 and dark portions 72 repeatedly appear on all of the mold original plate surfaces, it can be seen that the surfaces are not flat. In contrast, as illustrated in FIG. 10, with the resist film forming method according to an embodiment of the present disclosure, since a resist film having a high degree of uniformity is formed even for a thick film (e.g., 500 μm), the surface of the specimen (mold original plate) can be formed precisely and in a flat manner.

As described above, according to an embodiment of the present disclosure, by laminating resist layers while managing the amount of solvent that evaporates from the resist layers, a uniform amount of evaporated solvent can be ensured for each layer. Consequently, a clear pattern can be formed in the exposed resist film, and a development residue is not produced in the development performed after exposure. Therefore, a resist film that is more uniform and has a better quality than previously (e.g., 100 μm) can be formed even if the laminated resist film is thick (e.g., 500 μm).

Further, by performing oven heating in an oven chamber, a good quality resist film can be formed in which overheating of the bottommost layer or a resist layer that is close thereto is suppressed and in which a development residue is not produced.

In addition, by arranging a level gauge for precisely maintaining levelness on the lower side of the heating unit in the oven chamber, levelness during heating can be ensured and in-plane uniformity of the resist after coating can be improved.

### 2. Another Embodiment

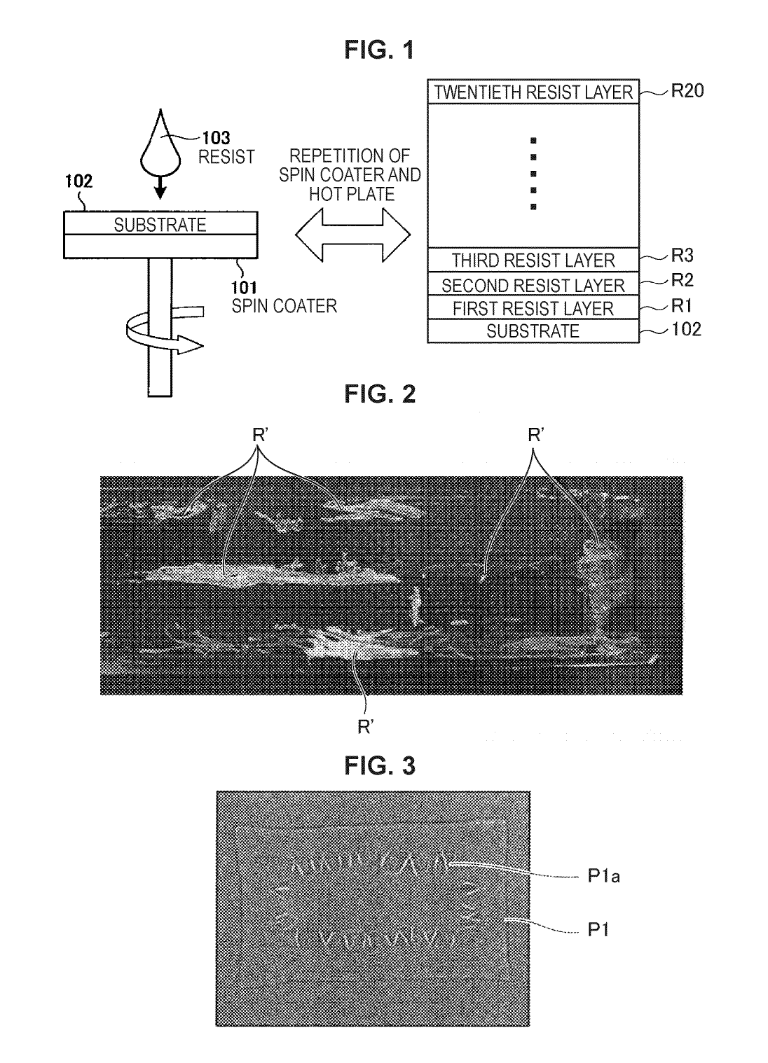

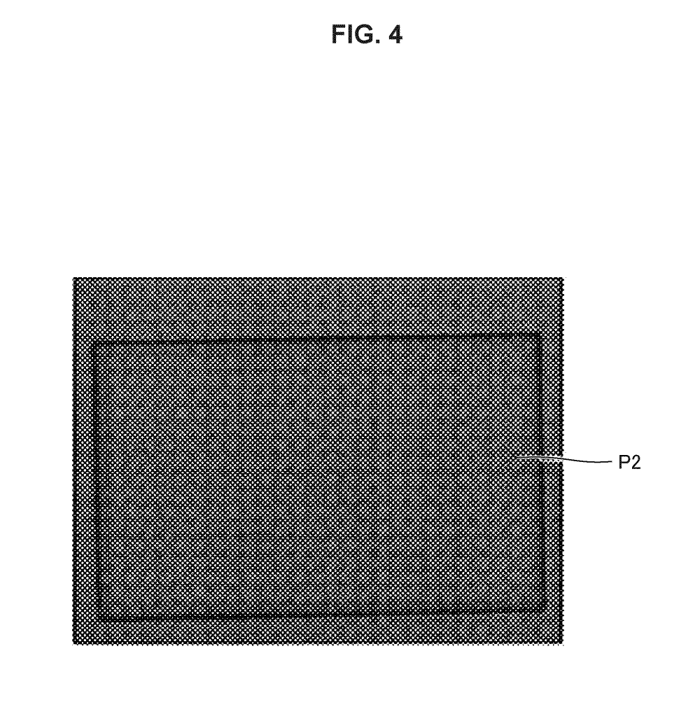

In the method for forming a resist film according to the above-described embodiment, the threshold for the amount of solvent evaporated from each resist layer constituting the plurality of resist layers could be set as a fixed value. However, as illustrated in FIG. 1, the threshold may be set differently for each resist layer to reflect the fact that the resist layers formed at an early stage are heated a greater number of times and thus tend to exhibit a greater amount of evaporation. For example, the threshold for the amount of solvent evaporated from the resist layers formed at an early stage may be lowered, and the threshold for the amount of solvent evaporated from the resist layers formed at a late stage may be successively increased, so that the amount of evaporation in the overall resist film approaches or is equal to a target value. Thus, if the threshold for the amount of evaporation is appropriately set in stages for each resist layer, the remaining solvent can be adjusted to a suitable level by individually adjusting the heating of the resist layers. Consequently, development residue can be prevented in the resist film formed from a plurality of resist layers, and the quality of the mold original plate can be improved.

In the resist film forming apparatus illustrated in FIG. 6, a thicker resist film is realized by providing one spin coater chamber 20 and one oven chamber 40, and moving the conveyance tray 22 back and forth between these chambers with the conveyance unit 31. However, serial film deposition (a line step) can also be carried out by providing a number of spin coater chambers 20 and oven chambers 40 that is equal to the number of layers to be laminated.

Additionally, the present technology may also be configured as below.
(1) A resist film forming apparatus, including:

a coating unit configured to drop, rotate, and spread a resist while rotating a substrate;

a heating unit configured to heat a specimen in which the resist is coated on the substrate;

a metering unit configured to measure a weight of the specimen being heated by the heating unit; and

a control unit configured to control lamination of a plurality of resist layers on the specimen by executing a process of forming a resist layer on the substrate by performing heating in the heating unit until a predetermined amount of solvent has evaporated from a resist coated on the specimen based on the weight of the specimen measured by the metering unit, and repeating for a predetermined number of times a process of forming a new resist layer on a resist layer formed on the specimen by similarly controlling the coating unit and the heating unit.
(2) The resist film forming apparatus according to (1),

wherein among the resist film to be formed, a threshold for an evaporation amount of the solvent is set so as to increase going from a bottommost resist layer to an uppermost resist layer, and

wherein the control unit is configured to control so that heating by the heating unit is performed until the amount of solvent that has evaporated from each layer reaches a corresponding threshold.
(3) The resist film forming apparatus according to (1) or (2), further including

a levelness maintenance unit configured to maintain levelness of the specimen when the specimen is being heated by the heating unit.
(4) The resist film forming apparatus according to any one of (1) to (3), wherein the heating unit is configured to confine and heat the specimen in a closed space.
(5) The resist film forming apparatus according to any one of (1) to (4), further including:

a conveyance tray arranged on a rotation stage of the coating unit, in which the specimen is placed on an upper face of the conveyance tray; and

a conveyance unit configured to convey the conveyance tray in a state in which the specimen is placed between the coating unit and the heating unit.
(6) The resist film forming apparatus according to any one of (1) to (5), wherein a cylindrical container is provided on an upper face of the substrate near an outer circumferential portion of the substrate.
(7) The resist film forming apparatus according to (6), wherein an adhesive is coated on a lower face of the cylindrical container, and the lower face of the cylindrical container and the upper face of the substrate are closely adhered.
(8) The resist film forming apparatus according to any one of (1) to (7), further including:

a first partition for partitioning a space where the coating unit is arranged and a space where the conveyance unit is arranged; and

a second partition for partitioning a space where the conveyance unit is arranged and a space where the heating unit is arranged,

wherein the control unit is configured to control at least so that the first partition is closed during resist coating by the coating unit, and the second partition is closed during heating by the heating unit.
(9) A method for forming a resist film, including:

dropping, rotating, and spreading a resist while rotating a substrate;

heating a specimen in which the resist is coated on the substrate;

measuring a weight of the specimen being heated;

executing a process of forming a resist layer on the substrate by performing heating until a predetermined amount of solvent has evaporated from a resist coated on the specimen based on the measured weight of the specimen; and

laminating a plurality of resist layers on the specimen by repeating for a predetermined number of times a process of forming a new resist layer on a resist layer formed on the specimen.
(10) A method for producing a mold original plate, including:

dropping, rotating, and spreading a resist while rotating a substrate;

heating a specimen in which the resist is coated on the substrate;

measuring a weight of the specimen being heated;

executing a process of forming a resist layer on the substrate by performing heating until a predetermined amount of solvent has evaporated from a resist coated on the specimen based on the measured weight of the specimen;

laminating a plurality of resist layers on the specimen by repeating for a predetermined number of times a process of forming a new resist layer on a resist layer formed on the specimen;

irradiating and exposing light on a resist film formed from the plurality of resist layers through a mask having an opaque portion; and

forming a predetermined pattern on the resist film by developing the exposed specimen.

The series of processes in the above-described exemplary embodiment can also be executed with hardware or software. If this series of processes is to be executed by software, a program configuring the software can be executed by a computer that is incorporated in dedicated hardware, or by a computer installed with a program for executing various functions. For example, a program configuring desired software can be installed and executed in a general-purpose personal computer and the like.

A recording medium on which a program code of software for realizing the functions of the above-described embodiment is recorded may be supplied to a system or apparatus. Needless to say, the functions of the above-described embodiment may also be realized by having a computer (or a calculation control apparatus such as a MPU or a CPU) of the system or apparatus read and execute the program code stored on the recording medium.

Examples of recording media which can be used for supplying such a program code include a flexible disk, a hard disk, an optical disk, a magneto-optical disk, a CD-ROM, a CD-R, a magnetic tape, a non-volatile memory card, a ROM and the like.

Further, the functions of the above embodiment may be realized by executing the program code read by the computer. The present disclosure also includes cases where, based on an instruction in the program code, an OS or the like running on the computer performs part or all of the actual processing, and by that processing the functions of the above-described embodiment are realized.

In the present specification, the processing steps describing chronological processes may of course be processed in chronological order in accordance with the stated order, but do not have to be processed in that chronological order. Further, the processing steps may be processed individually or in a parallel manner (e.g., parallel processing or object-based processing).

The present disclosure is not limited to the above-described embodiments, and obviously may incorporate various modifications and applications within the scope of the patent claims.

Namely, because the above-described embodiments are specific preferred examples of the present disclosure, they are subject to various preferred technical limitations. However, the technical scope of the present disclosure is not limited to these embodiments unless such a limitation is specifically stated in the above description. For example, the used materials, used amounts, processing time, processing order, numerical conditions of the various parameters and the like are merely preferred examples. Further, the dimensions, shapes, and positional relationships illustrated in the drawings used in the present disclosure are also schematic representations.

The present disclosure contains subject matter related to that disclosed in Japanese Priority Patent Application JP 2011-218468 filed in the Japan Patent Office on Sep. 30, 2011, the entire content of which is hereby incorporated by reference.

What is claimed is:

1. A resist film forming apparatus, comprising:
a coating unit configured to drop, rotate, and spread a resist while rotating a substrate;
a heating unit configured to heat a specimen in which the resist is coated on the substrate;
a metering unit configured to measure a weight of the specimen being heated by the heating unit; and
a control unit configured to control lamination of a plurality of resist layers on the specimen by executing a process of forming a resist layer on the substrate by performing heating in the heating unit until a predetermined amount of solvent has evaporated from a resist coated on the specimen based on the weight of the specimen measured by the metering unit, and repeating for a predetermined number of times a process of forming a new resist layer on a resist layer formed on the specimen by similarly controlling the coating unit and the heating unit.

2. The resist film forming apparatus according to claim 1,
wherein among the resist film to be formed, a threshold for an evaporation amount of the solvent is set so as to increase going from a bottommost resist layer to an uppermost resist layer, and
wherein the control unit is configured to control so that heating by the heating unit is performed until the amount of solvent that has evaporated from each layer reaches a corresponding threshold.

3. The resist film forming apparatus according to claim 2, further comprising
a levelness maintenance unit configured to maintain levelness of the specimen when the specimen is being heated by the heating unit.

4. The resist film forming apparatus according to claim 3, wherein the heating unit is configured to confine and heat the specimen in a closed space.

5. The resist film forming apparatus according to claim 4, further comprising:
a conveyance tray arranged on a rotation stage of the coating unit, in which the specimen is placed on an upper face of the conveyance tray; and
a conveyance unit configured to convey the conveyance tray in a state in which the specimen is placed between the coating unit and the heating unit.

6. The resist film forming apparatus according to claim 5, wherein a cylindrical container is provided on an upper face of the substrate near an outer circumferential portion of the substrate.

7. The resist film forming apparatus according to claim 6, wherein an adhesive is coated on a lower face of the cylindrical container, and the lower face of the cylindrical container and the upper face of the substrate are closely adhered.

8. The resist film forming apparatus according to claim 1, further comprising:
a first partition for partitioning a space where the coating unit is arranged and a space where the conveyance unit is arranged; and
a second partition for partitioning a space where the conveyance unit is arranged and a space where the heating unit is arranged,
wherein the control unit is configured to control at least so that the first partition is closed during resist coating by the coating unit, and the second partition is closed during heating by the heating unit.

9. A method for forming a resist film, comprising:
dropping, rotating, and spreading a resist while rotating a substrate;
heating a specimen in which the resist is coated on the substrate;
measuring a weight of the specimen being heated;
executing a process of forming a resist layer on the substrate by performing heating until a predetermined amount of solvent has evaporated from a resist coated on the specimen based on the measured weight of the specimen; and
laminating a plurality of resist layers on the specimen by repeating for a predetermined number of times a process of forming a new resist layer on a resist layer formed on the specimen.

10. A method for producing a mold original plate, comprising:
dropping, rotating, and spreading a resist while rotating a substrate;
heating a specimen in which the resist is coated on the substrate;
measuring a weight of the specimen being heated;
executing a process of forming a resist layer on the substrate by performing heating until a predetermined amount of solvent has evaporated from a resist coated on the specimen based on the measured weight of the specimen;
laminating a plurality of resist layers on the specimen by repeating for a predetermined number of times a process of forming a new resist layer on a resist layer formed on the specimen;
irradiating and exposing light on a resist film formed from the plurality of resist layers through a mask having an opaque portion; and
forming a predetermined pattern on the resist film by developing the exposed specimen.
